(19) United States
(12) Patent Application Publication
(10) Pub. No.: US 2018/0345293 A1
(43) Pub. Date: Dec. 6, 2018

(54) A crusher for rubble

(71) Applicant: CAMS S.R.L., Castel San Pietro Terme (IT)

(72) Inventor: Marco Venturi, Bologna (IT)

(21) Appl. No.: 15/779,507

(22) PCT Filed: Oct. 27, 2016
(86) PCT No.: PCT/IB2016/056453

§ 371 Date: May 25, 2018

(30) Foreign Application Priority Data
Dec. 23, 2015 (IT) 102015000087105

(51) Int. Cl. B02C 18/22; B02C 18/14

(52) U.S. Cl. CPC B02C 18/2233; B02C 18/142

(57) ABSTRACT

A crusher for rubble includes a crushing chamber in which the nibbles are grounded, a grinding group inserted in the crushing chamber to grind the rubble, and a conveying channel of the rubble into the grinding group. The crusher includes two or more pushers, which act in the conveying channel toward the grinding group to push the rubble against the grinding group, and which controlled separately from each other, so to be able to be placed at rest separately when one or more of the others are actuated.

### FIELD OF INVENTION

The present invention is generally applicable to the technical construction and services fields, and it particularly refers to the treatment of residues of construction elements such as debris resulting from demolition of buildings or from the removal or rebuilding of roads or other similar works.

More in detail, the present invention relates to a crusher for rubble.

### BACKGROUND OF THE INVENTION

By demolishment, even partial, of buildings for reconstruction, or due to destructive events, as well as the rebuilding of roads or other several works of man, large size debris are typically generated. These should be obviously disposed, and often their size, combined with the weight that consequently they have, make its disposal difficult, if not daunting.

To that effect it is known different types of rubble crushers. Among them, one of the most effective is constituted by machines that have a casing, inside which the cutters are positioned, which grip the rubble and shred them, reducing it into small size elements.

Usually crushers are equipped with a loading hopper arranged above the cutters, where the bulldozers, cranes or similar can upload the rubble to be shredded.

Regarding the cutters, they are generally constituted by rotary units made assembling a plurality of mutually coaxial discs fitted on the periphery of the crushing teeth. The discs are typically interspersed with spacers so that two rotors can be placed frontally to each other and partially interpenetrate, arranging the discs of one rotor in correspondence with the spacer of the other rotor.

The two rotors are made to rotate in an opposite direction between each other, so that with such rotation the teeth in the periphery of the discs of a rotor can cooperate with the teeth in the periphery of the discs of the other rotor, grasping the rubble between them and compressing them until they break.

Since the rubble from the hopper are directed towards the interpenetration zone between the rotors, and then they must come out downward near the same interpenetration zone, it is evident that the grasping and fragmentation process of the rubble continues until the size of the fragments become small enough to pass through the detectable spaces between the two rotors.

Sometimes it happens that the size of the rubble is of such dimensions as to constitute a sort of cap in the hopper. To that effect other crushers are well known such as the ones described in the patent documents CN 202657508 U and CN 204182447 U, in which are present the pushers that act on the rubble to remove the aforementioned cap. In other words, the pushers alternately hit the rubble to ensure that they continue their downward process towards the cutters.

However, when come in place, it may happen that there are some substantially plate elements that are disposed parallel to the shredding zone, and that the teeth of the crusher are not able to crush. These elements usually are particularly resistant, to which bounce on the teeth and, in fact, “float” over the shredding zone without being scratched.

This constitutes a problem since it forces the operators to intervene by interrupting the production by stopping the system in order to extract these parts form the supplying hopper, and ensuring other means to break up the artifacts. This operation, other than being itself dangerous, slows down the rubble disposal process. In addition, it may happen that some particular plate-like elements, that individually would have dimensions compatible with the grasping capacity of the crusher, when they arrive in the hopper in a high quantity, they interact with each other and “float” over the shredding zone.

### SUMMARY OF THE INVENTION

Object of the present invention is to at least partially overcome the abovementioned drawbacks, by providing a crusher of rubble that ensures its shredding without the need of the intervention of operators, particularly in cases where “floating” rubble above the grinding group.

Another object is that the crusher of the invention can guarantee the complete shredding of the rubble without the operators intervention, even in case of plate-like and particularly resistant elements.

A further object of the invention is that this crusher of rubble guarantees shredding rates as high as possible.

Another object is that the crusher of rubble can have levels of execution complexity and associated costs at most equivalent, if not inferior, to the equivalent already known crushers.

Such objects, and others that will appear more clearly hereinafter, are fulfilled by a crusher of rubble according to the following claims, which are to be considered an integral part of the present application.

In particular, the crusher comprises a crushing chamber in which the rubble is crushed, and at least one crushing group inserted in the same chamber for crushing the rubble. It also comprises at least one conveying channels of the rubble towards the crushing group and usually, but not necessarily, a loading hopper.

According to an aspect of the invention, the crusher includes also two or more pushers acting in the conveying channel towards the crushing group, in order to push the rubble against this last one.

In other words, the pushers act on the rubble pressing them against the crushing group so that they are completely crushed from it.

Advantageously, therefore, any eventual “floating” elements on the crushing group will be pushed in the crushing zone, obtaining the complete crushing of the rubble without the need of an operator's intervention.

By the pushing carried out, the pushers actively cooperate to crush the rubble accelerating the process.

According to another aspect of the invention, at least one of the pushers is separately and independently controlled in respect to the others, so that it can be placed in the rest position for a while when one or more of the others are acting in the conveying channel.

In other words, the pushers do not act necessarily all together at the same time, but one or more of them can be acted independently from the others.

This allows, advantageously, to increase considerably the crushing process rate. In fact, if the pushers would act in thrust all at once, it would be necessary to wait until the end of the previous crushing process until it could be able to make a further load of rubble. In the case of the invention, however, until one or more pusher are in action, one or more of the others can be placed to the rest position so that in its working space can be loaded additional rubble to be crushed. Consequently, with the crusher of the invention, the crushing process can be continuous without having to stop it to proceed with further loads of rubble.

### BRIEF DESCRIPTION OF THE DRAWINGS

Further features and advantages of the invention will appear more evident by reading the detailed description of a preferred, but not exclusive, embodiment of a crusher of rubble according to the invention, shown as non-limitative example with the help of the annexed drawings, wherein:

FIG. 1 shows a crusher for rubble according to the invention in a partially sectioned perspective view;

FIGS. 2 and 3 show some details of the crusher for rubble according to FIG. 1.

### DETAILED DESCRIPTION OF AN EXAMPLE OF A PREFERRED EMBODIMENT

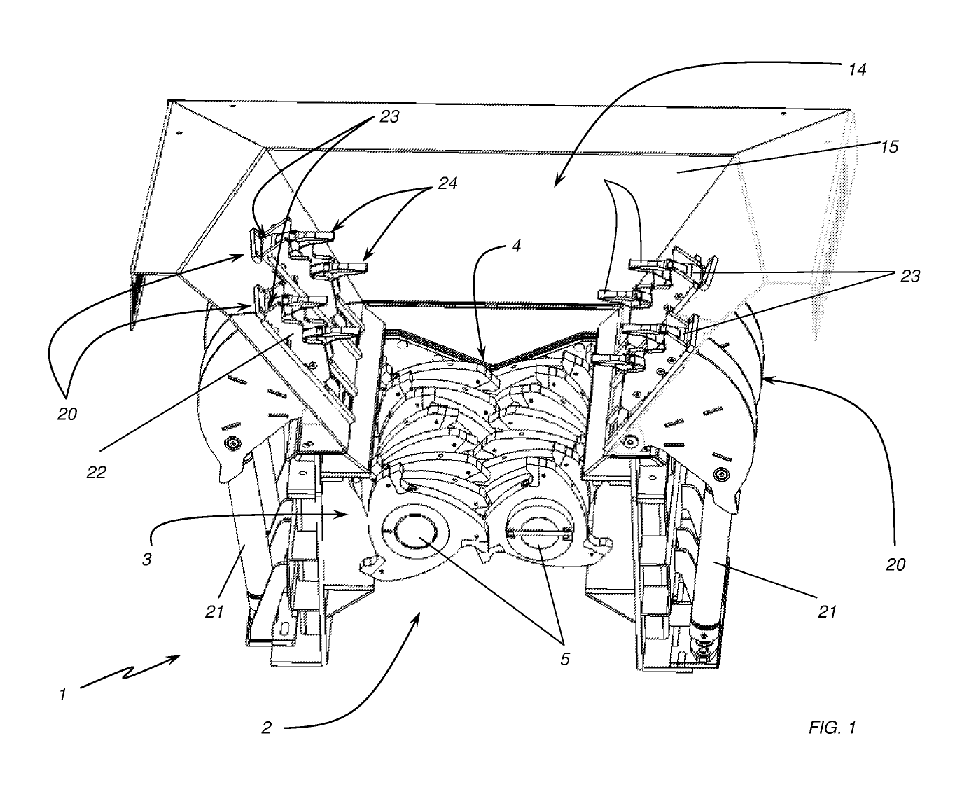

With reference to the above figures, and particularly to FIG. 1, it is described a crusher for rubble 1. It is commonly used for crushing rubble resulting from the dismantling of walls, roads or similar works.

To that effect, it includes a crushing chamber 2 in which the rubble is crushed. For this purpose, in the crushing chamber 2 there is a crushing group 3.

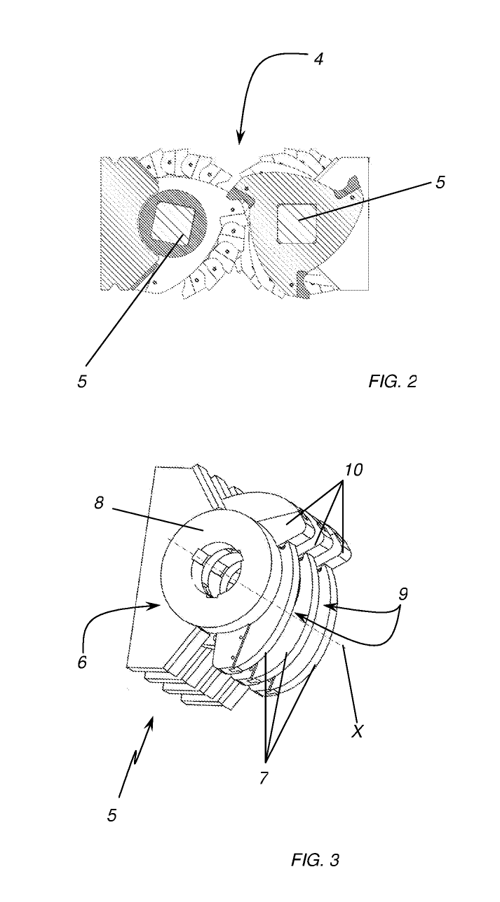

In the described embodiment, it is composed, as observed also in FIG. 2, by a pair of cutters 5 placed frontally from each other, and that at least partially interpenetrate between them. Among them, it is identifiable a crushing zone 4 for rubble.

According to an aspect of the invention, each cutter 5 includes, as observed in FIG. 3, a rotor 6 with a plurality of grinder discs 7. These are arranged coaxially to the rotation axis X of the rotor 6. In addition, they are interspersed with spacers 8. In other words, between each adjacent pair of grinder discs 7 of each cutter 5 there is a fissuring 9 in correspondence of a spacer. In this manner, it is possible to partially penetrate the two cutters 5 disposed frontally to each other by matching a grinder disc 7 of a cutter 5 to a spacer 8 of the other.

On the circumference of the grinder discs 7 are placed crushing teeth 10 which have cutting edges in order to facilitate the crushing of the rubble.

Obviously, the numbers of cutters as well as the described embodiment of the crushing group or of the cutters are to be considered examples of embodiments of the invention not limiting for different embodiments.

Also the number of crushing chambers and crushing groups are not limitative characteristics for the invention.

According to an aspect of the invention, the crusher 1 also includes a conveying channel 14 that, in the embodiment that is being described, is constituted by a loading hopper 15 to accommodate the rubble and route them into the crushing chamber 2 in the direction of the crushing group 3. In the figure it is observed that the crusher 1 has a vertical operating conformation, so that the rubble is inserted superiorly to the hopper 15 from which glide towards the crushing group 3. Also this detail is not to be considered limitative for different embodiments of the invention, where the hopper is absent or where the operative configuration of the crusher is inclined or even horizontal, or where following the hopper there is a further element of the conveying channel having another shaping.

In the operational phase, the two cutters 5 are then made to rotate in opposite directions, so that the crushing teeth 10 of both cutters cooperate to better grasp the rubble between them, as between two jaws that tighten the rubble until its rupture. The shaping edges of the crushing teeth 10 actively cooperate to crush and grind the rubble.

Where in the rubble are present plate-like and/or particularly tenacious elements, they may not fit in the crushing zone 4, but “float” over it. This, as previously mentioned, would compel operators to intervene.

In order to avoid such drawback, the crusher 1 of the invention comprises two or more pushers 20 acting in the conveying channel 14 towards the crushing group 3 to push the rubble against it.

Particularly, the pushers 20 act on the rubble pressing them against the crushing group 3 so that they are totally crushed so avoiding, advantageously, the “floating” of rubble.

It is observed, moreover, that the same pushers 20, with the thrust exerted towards the crushing group 3, cooperate directly to the crushing of the rubble, and also, thanks to the lifting action carried out against any eventual plate-like elements, allow a much easier conveying of these elements towards the center of the crushing chamber 2, so overcome the abovementioned risk of “floating”.

According to another aspect of the invention, each pusher 20 is separately and independently controlled from the others. This allows, advantageously, to operate some pushers 20 as desired while the others are putted in the rest position for a while. Consequently with the same pushers 20 it can be created a combined crushing action also in a parallel direction to the crushing zone 4, facilitating the oblique arrangement of the rubble elements.

Still advantageously, the crushing process is greatly accelerated. In fact, if the pushers 20 would act in thrust all at once, it would have to wait until the total crusching of the previous loaded rubble before proceeding with a further loading. In the case of the invention, however, until one or more pushers 20 are in action, one or more of the other can be placed in the rest position for the time necessary to load additional rubbles. Consequently, with the crusher 1 of the invention, the crushing process can be continuous without having to stop it to proceed with the load of further rubbles.

It is evident that the number of pushers, as well as the fact that they are all separately controlled, are not limitative characteristics for the invention. What is important is that the pushers are at least two, and that there is at least one or at least one subset of pushers separately controlled from the others.

According to a further aspect of the invention, each pusher 20 comprises an actuator 21 that works on a pusher head 22 which, in its turn, is shaped to push the rubbles against the crushing group 3.

It is evident that also the embodiment of the pushers just described must not be considered limitative for the invention. Not only the number of actuators and plates by pusher can be variable, but also the effective embodiment of the pusher can be completely different than that abovementioned.

According to another aspect of the invention, on the surface 23 of the pushing head 22 facing the crushing group 3, are made shaped projections 24 that cooperate with the same grinding group 3 for crushing the rubble.

In other words, the shaped projections 24 substantially carried out teeth that, during the push by the pusher 20 towards the crushing group 3, exert a rupture action on the rubble, thereby increasing the active cooperation of the pushers 20 to the crushing process.

More in detail, the shaped projections 24 have a shape counter-shaped over the shape of the correspondent portion of the crushing group 3 against which they act so as to interpenetrate with the same crushing group 3, accelerating the crushing action.

Even this last aspect of the invention, however, is to be considered not limitative.

Operatively, therefore, after the first load of rubbles in the conveying channel 14, the pushers 20, initially placed in the rest position, are actuated to push the rubbles against the crushing group 3 and cooperate with it to the crushing. When the amount of rubble to be crushed decreases, one or more pusher 20 are raised in order to allow the load of further rubbles in their areas.

In case of rubble elements particularly tenacious, the pushers 20 can also be serially and alternately raised and re-lowered to increase its crushing action in cooperation with the crushing group 3.

As said, it is evident that the crusher for rubble of the invention achieves all the intended purposes.

Particularly, it allows the shredding of rubble without the operators intervention, particularly in case of “floating” elements over the grinding group, or in case of particularly tenacious plate-like elements.

In addition, the invention allows shredding rates as high as possible, while still maintaining execution and cost levels at least equivalent, if not inferior, to the equivalent already known crushers.

The invention is susceptible to several modifications e variations, all falling within the inventive concept expressed in the claims. All the details may be replaced by other technically equivalent elements, and the materials may be different according to requirements, without departing the scope of the invention defined by the appended claims.

The invention claimed is:

1. A crusher for rubble comprising:
a crushing chamber (2), in which the rubble is crushed;
at least one crushing group (3) inserted into said crushing chamber (2) for crushing the rubble; and
at least one conveying channel (14) of the rubble toward said crushing group (3),
wherein the crusher comprises two or more pushers (20) acting in said conveying channel (14) toward said crushing group (3) to push the rubble against said crushing group (3), at least one of said pushers (20) being separately and independently controlled from the other pusher or pushers so as to move said at least one of said pushers in a rest position for a while when one or more of the other pusher or pushers are working in the conveying channel (14).

2. The crusher as claimed in claim 1, wherein said pushers (20) comprise at least one actuator (21) acting on at least one pusher head (22) of the rubble against said crushing group (3).

3. The crusher as claimed in claim 2, further comprising shaped projections (24) on a surface (23) of said pusher head (22) facing towards said crushing group (3) to cooperate with the crushing group in crushing the rubble.

4. The crusher as claimed in claim 3, wherein said crushing group (3) is counter-shaped in areas against which said shaped projections (24) act.

5. The crusher as claimed in claim 1, wherein said conveying channel (14) comprises at least one loading hopper (15).

6. The crusher as claimed in claim 1, wherein said crushing group (3) comprises one or more cutters (5).

7. The crusher as claimed in claim 6, wherein each of said cutters (5) comprises a rotor (6) provided with a plurality of grinder discs (7) arranged coaxial to a rotation axis (X) of said rotor (6) and spaced out by spacers (8).

8. The crusher as claimed in claim 7, wherein said crushing group (3) comprises a pair of said cutters (5) facing one another and which at least partially penetrate, said grinder discs (7) of one cutter inserting in an interstice between a pair of grinder discs (7) of another cutter.
